(19) United States
(12) Patent Application Publication
(10) Pub. No.: US 2012/0044144 A1
(43) Pub. Date: Feb. 23, 2012

(54) COMPUTER MOUSE HAVING SOUND-BOX FUNCTION

(75) Inventors: XIAN-KUI CHEN, Shenzhen City (CN); HAI-LI WANG, Shenzhen City (CN); GUAN WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/871,857

(22) Filed: Aug. 30, 2010

(30) Foreign Application Priority Data
Aug. 17, 2010 (CN) 201010255322.2

(51) Int. Cl. G06F 3/033

(52) U.S. Cl. 345/163

(57) ABSTRACT

A computer mouse includes a connector, a mouse circuit, a sound box, an audio circuit, and a hub. The audio circuit is connected to the sound box. The hub is connected to the connector through a cable, and connected to the mouse circuit and the audio circuit. The audio circuit receives audio signals from the connector through the hub, and outputs the received audio signals through the sound box.

### BACKGROUND

1. Technical Field

The present disclosure relates to computer mice and, particularly, to a computer mouse having a sound-box function.

2. Description of Related Art

A computer generally includes a host computer, a monitor, a keyboard, a mouse, and an individual speaker as separate components. It is inconvenient to have so many separate parts as well as costly. At present, mice are generally uni-functional, only being used as input devices of computers. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an exemplary embodiment of a computer mouse having a sound-box function.

FIG. 2 is a block diagram of the computer mouse of FIG. 1.

### DETAILED DESCRIPTION

The disclosure, including the drawings, is illustrated by way of example and not by limitation. It should be noted that references to “an” or “one” embodiment in this disclosure are not necessarily to the same embodiment, and such references mean at least one.

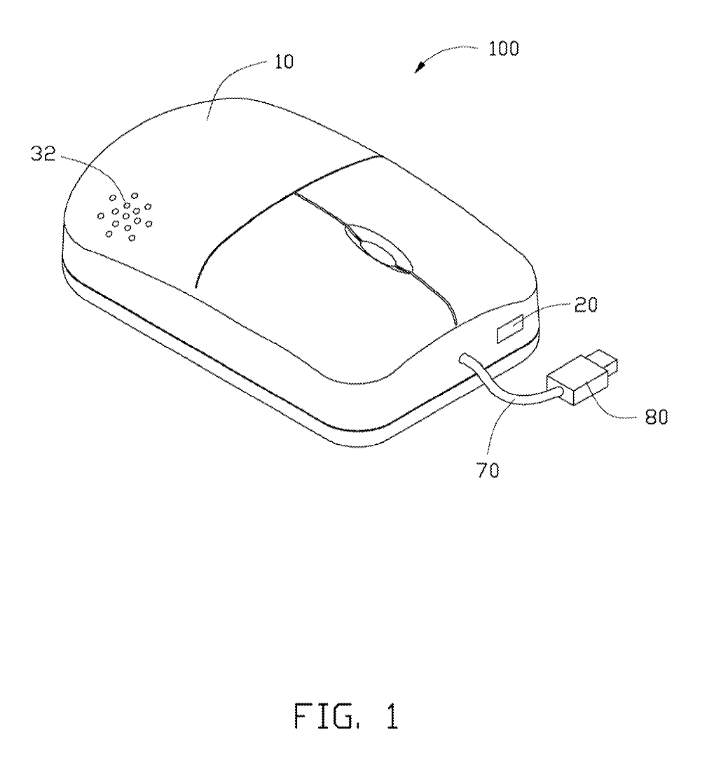

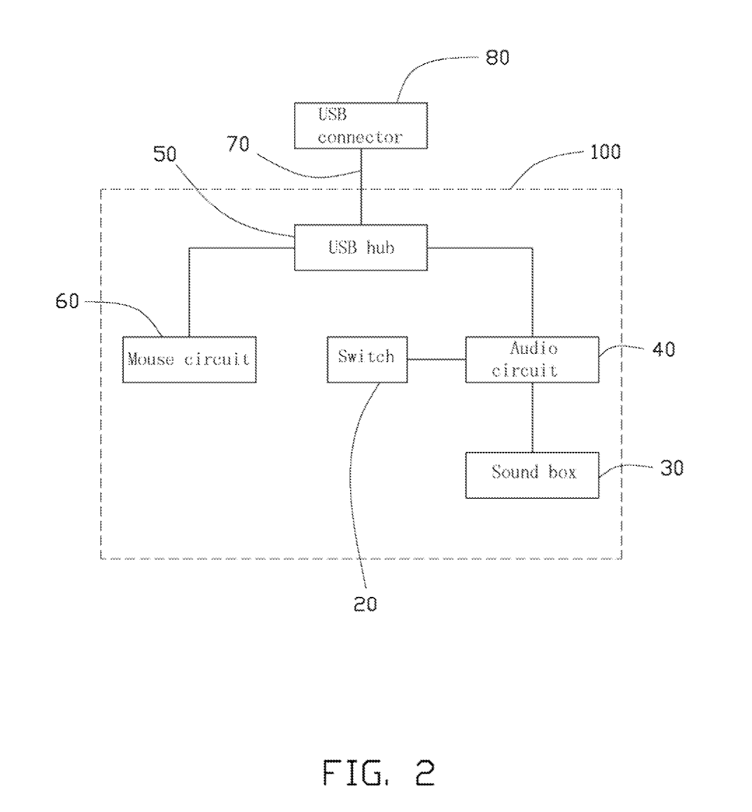

Referring to FIGS. 1 and 2, an embodiment of a computer mouse 100 having a sound-box function includes a shell 10, a switch 20, a sound box 30, an audio circuit 40, an universal serial bus (USB) hub 50, and a mouse circuit 60. In one embodiment, the switch 20 is a button switch. The sound box 30 is a speaker. The switch 20 and the sound box 30 are set on the shell 10. The shell 10 defines at least one sound hole 32 therein, aligning with the sound box 30. In one embodiment, the sound box 30 is set on an inner surface of a top of the shell 10, and the switch 20 is set on a front side surface of the shell 10. In other embodiments, the sound box 30 and the switch 20 can be set on other locations of the shell 10 according to need.

The USB hub 50 is connected to a USB connector 80 through a cable 70. The USB hub 50 is also connected to the mouse circuit 60 and the audio circuit 40. The audio circuit 40 is connected to the sound box 30. The switch 20 is connected to the audio circuit 40.

In use, the USB connector 80 is connected to a USB interface of a host computer, to communicate the mouse 100 with the host computer. When the sound box 30 is not on, the mouse 100 functions only as an input device, namely, the mouse circuit 60 receives operation signals input by a user and outputs the operation signals to the host computer through the USB hub 50 and the USB connector 80. The host computer controls the computer according to the received operation signals. When the computer operates an audio file, namely, the host computer outputs audio signals to the audio circuit 40 through the USB connector 80 and the USB hub 50, and if the switch 20 is pressed to turn on the sound box 30, the audio circuit 40 outputs the audio file through the sound box 30, and sound comes out through the sound hole 32. When the switch 20 is pressed again, the sound box 30 is turned off, the audio circuit 40 does not output the audio file through the sound box 30.

The mouse 100 not only can be used as an input device of the computer, but also can be used as a speaker, saving cost and space.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer mouse having sound-box function, the computer mouse comprising:
a connector;
a mouse circuit;
a sound box;
an audio circuit connected to the sound box; and
a hub connected to the connector through a cable, and connected to the mouse circuit and the audio circuit;
wherein the audio circuit receives audio signals from the connector through the hub, and outputs the received audio signals through the sound box.

2. The computer mouse of claim 1, further comprising a switch connected to the audio circuit, to turn on or turn off the audio circuit.

3. The computer mouse of claim 2, wherein the switch is a button switch.

4. The computer mouse of claim 1, wherein the sound box is a speaker.

5. The computer mouse of claim 1, further comprising a shell enclosing the mouse circuit, the sound box, the audio circuit, and the hub, wherein at least one sound hole is defined in the shell and aligns with the sound box.

6. The computer mouse of claim 1, wherein the hub is a universal serial bus (USB) hub, and the connector is a USB connector.
